(19) United States
(12) Patent Application Publication
(10) Pub. No.: US 2026/0320648 A1
(43) Pub. Date: Oct. 15, 2026

(54) INFORMATION PROCESSING APPARATUS, INFORMATION PROCESSING METHOD, AND NON-TRANSITORY COMPUTER READABLE MEDIUM

(71) Applicant: Rakuten Group, Inc., Tokyo (JP)

(72) Inventor: Meetkumar SONI, Tokyo (JP)

(73) Assignee: Rakuten Group, Inc., Tokyo (JP)

(21) Appl. No.: 19/467,109

(22) Filed: Feb. 2, 2026

(30) Foreign Application Priority Data
Feb. 26, 2025 (JP) 2025-028719

(51) Int. Cl. G06Q 30/0242

(52) U.S. Cl. CPC G06Q 30/0244

(57) ABSTRACT

An information processing apparatus divides a user group consisting of a plurality of users into a first user group for which a treatment for encouraging a predetermined conversion has been performed, and a second user group for which the treatment has not been performed, estimates a first probability that a user who has reached the conversion is included in the first user group, and a second probability that a user who has reached the conversion is included in the second user group, estimates a third probability that is an overall probability that the conversion has been reached within the user group, and calculates an uplift score representing an effect of the treatment with respect to the user group, using the first probability, the second probability, and the third probability.

### CROSS-REFERENCE TO RELATED APPLICATION(S)

This application claims priority to Japanese patent application No. 2025-028719, filed on Feb. 26, 2025; the entire contents of which are incorporated herein by reference.

### TECHNICAL FIELD

The present invention relates to a technology for calculating an uplift score.

### BACKGROUND ART

In the field of advertising, it is difficult to determine whether a purchase made by a user following a specific treatment (i.e., implementing a marketing measure such as distributing a coupon) can truly be attributed to the effect of the treatment. Meanwhile, acquiring such knowledge can increase the efficiency of marketing activities. For example, when an advertisement including a coupon is distributed online, it is possible to select, as targets, users who will make a purchase if they receive the coupon, and deliver the advertisement only to the targets. In this way, it can be expected to enhance the effect and efficiency of marketing activities by distributing advertisements while narrowing down the targets for which the effect of the advertisements can be expected.

Uplift modeling is known as a method for selecting a target expected to enhance the treatment effect as mentioned above. Uplift modeling is a method for estimating which user should be targeted for a treatment in order to increase the treatment effect. In uplift modeling, an uplift score, which is an indicator for selecting a target, is calculated, and the target is estimated based on the calculated uplift score.

For example, as described in JP 2024-131197A, the uplift score can be calculated based on a difference between a probability that a purchase is made if a treatment is performed and a probability that a purchase is made if no treatment is performed. It can be considered that the higher the uplift score, the higher the treatment effect. Therefore, by selecting a user group having a higher uplift score as a target, marketing activities expected to exhibit a higher treatment effect can be implemented.

JP 2024-131197A is an example of related art.

Dmitri Goldenberg et al., “Free Lunch! Retrospective Uplift Modeling for Dynamic Promotions Recommendation within ROI Constraints”, August 2020, arXiv: 2008.06293. (hereinafter, “NPL1”) is an example of related art.

### SUMMARY OF THE INVENTION

As disclosed in JP 2024-131197A, according to a conventional uplift calculation method, the uplift score can be calculated based on a difference between the probability of purchasing if a treatment is performed and the probability of purchasing if no treatment is performed. However, this calculation method does not consider the overall probability that a purchase has actually been made among all the users (i.e., the probability that a conversion has been reached among them). By considering the overall probability that a purchase has been made among all the users, the uplift score, which is an indicator for selecting a target, can be an indicator more representative of a purchase trend.

In view of the above problem, the present disclosure aims to provide a technology for calculating an uplift score that represents a purchase trend.

To solve the above problem, one aspect of an information processing apparatus according to the present invention includes: a grouping unit configured to divide a user group consisting of a plurality of users into a first user group for which a treatment for encouraging a predetermined conversion has been performed, and a second user group for which the treatment has not been performed; a first estimation unit configured to estimate a first probability that a user who has reached the conversion is included in the first user group, and a second probability that a user who has reached the conversion is included in the second user group; a second estimation unit configured to estimate a third probability that is an overall probability that the conversion has been reached within the user group; and a calculation unit configured to calculate an uplift score representing an effect of the treatment with respect to the user group, using the first probability, the second probability, and the third probability.

To solve the above problem, one aspect of an information processing method according to the present invention includes: dividing a user group consisting of a plurality of users into a first user group for which a treatment for encouraging a predetermined conversion has been performed, and a second user group for which the treatment has not been performed; estimating a first probability that a user who has reached the conversion is included in the first user group, and a second probability that a user who has reached the conversion is included in the second user group; estimating a third probability that is an overall probability that the conversion has been reached within the user group; and calculating an uplift score representing an effect of the treatment with respect to the user group, using the first probability, the second probability, and the third probability.

To solve the above problem, one aspect of an information processing program is an information processing program for causing a computer to execute: grouping processing for dividing a user group consisting of a plurality of users into a first user group for which a treatment for encouraging a predetermined conversion has been performed, and a second user group for which the treatment has not been performed; first estimation processing for estimating a first probability that a user who has reached the conversion is included in the first user group, and a second probability that a user who has reached the conversion is included in the second user group; second estimation processing for estimating a third probability that is an overall probability that the conversion has been reached within the user group; and calculation processing for calculating an uplift score representing an effect of the treatment with respect to the user group, using the first probability, the second probability, and the third probability.

According to the present invention, a technology for calculating an uplift score that represents a purchase trend is provided.

A person skilled in the art will be able to understand the above-stated object, aspect, and advantages of the present invention, as well as other objects, aspects, and advantages of the present invention that are not mentioned above, from the following modes for carrying out the invention by referring to the accompanying drawings and claims.

### BRIEF DESCRIPTION OF THE DRAWINGS

FIG. 1 shows an example configuration of an information processing system according to one embodiment.

FIG. 2 is a conceptual diagram of uplift score calculation processing according to one embodiment.

FIG. 3 shows an example functional configuration of an electronic commerce server according to one embodiment.

FIG. 4 shows an example functional configuration of an information processing apparatus according to one embodiment.

FIG. 5 shows an example hardware configuration of the information processing apparatus according to one embodiment.

FIG. 6 is a flowchart of processing executed by the information processing system according to one embodiment.

### EMBODIMENTS OF THE INVENTION

Embodiments of the present invention will now be described in detail with reference to the accompanying drawings. Out of the component elements described below, elements with the same functions have been assigned the same reference numerals, and description thereof is omitted. Note that the embodiments disclosed below are mere example implementations of the present invention, and it is possible to make changes and modifications as appropriate according to the configuration and/or various conditions of the apparatus to which the present invention is to be applied. Accordingly, the present invention is not limited to the embodiments described below. The combination of features described in these embodiments may include features that are not essential when implementing the present invention.

### Configuration of Information Processing System

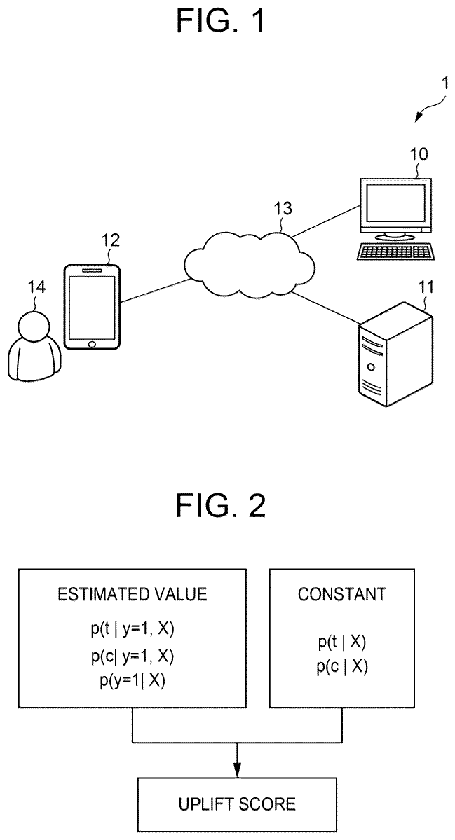

FIG. 1 shows an example configuration of an information processing system 1 according to the present embodiment. The information processing system 1 includes an information processing apparatus 10, an electronic commerce server 11, and a user device 12. The information processing apparatus 10, the electronic commerce server 11, and the user device 12 can communicate with each other via a network 13. The network 13 may include the internet, as well as any other type of network such as an intranet, local area network (LAN), wide area network (WAN), or mobile communication network. Although FIG. 1 shows one user device 12, the information processing system 1 is configured to include a plurality of user devices having the same functionality as the user device 12. In the present disclosure, the plurality of user devices are collectively referred to as the “user device 12”. The user device 12 is operated by a user 14. In the present disclosure, the terms “user device” and “user” may be understood as synonyms.

The electronic commerce server 11 is a server device capable of providing services for electronic commerce. In the description of the present disclosure, the electronic commerce server 11 is a server device that operates an e-commerce mall (mall-type e-commerce site), which is an online shopping mall with a plurality of stores. Specifically, the electronic commerce server 11 operates an e-commerce mall, which is a shopping mall constituted by sales pages (web pages) for products sold by a plurality of stores (merchants). The e-commerce mall sells items including tangible and/or intangible products and services. The following description deals with a product, but the same description is applicable to other items.

The electronic commerce server 11 can be accessed by the user 14 from the user device 12 via the network 13, and provide the user 14 with various services related to shopping at the e-commerce mall. For example, the user 14 accesses the e-commerce mall and performs an action such as a purchase or a click on a sales page for any product. In response to this, the electronic commerce server 11 provides the user 14 with a service related to this product. Also, the electronic commerce server 11 can acquire (collect) and manage information related to a click or a purchase performed by the user 14 on a sales page for a product sold in the e-commerce mall. In the present disclosure, the term “conversion” refers to an action expected to be performed by a user who uses a service for electronic commerce provided by the electronic commerce server 11, such as a purchase of an item provided by this service. For example, the conversion includes an action that is performed by the user 14, such as a click or a purchase on a sales page, which the operator of the electronic commerce server 11 expects the user 14 to perform on the e-commerce mall.

The electronic commerce server 11 can perform any treatment in order to encourage a user of a service for electronic commerce to perform a conversion. For example, the electronic commerce server 11 performs a treatment by distributing an advertisement related to a service for electronic commerce (e-commerce mall in the present embodiment). The advertisement may include information such as a coupon and a discount ticket that can be used on the service. The electronic commerce server 11 may distribute an advertisement using, for example, a banner or the like on the e-commerce mall accessed by a user, and may also distribute or provide an advertisement using an e-mail or other means.

In the present disclosure, a user for which any (e.g., predetermined) treatment is performed is also referred to as a “treated user”. Meanwhile, in the present disclosure, controlling a service or the like while not performing the predetermined treatment is referred to as “control”, and a user for which any treatment is not performed is also referred to as a “control user”. As will be described later, the electronic commerce server 11 can determine which user is to be a treated user, based on an uplift score calculated by the information processing apparatus 10.

The user 14 can operate the user device 12 to access the electronic commerce server 11 and receive various services provided by the electronic commerce server 11. In the present disclosure, the user 14 can receive various services in the e-commerce mall provided by the electronic commerce server 11. For example, the user 14 can operate the user device 12 and access the e-commerce mall to view sales pages for various products provided by the e-commerce mall and purchase the products sold on these sales pages. The user 14 can purchase a product by adding it to a cart on a sales page for the product, inputting predetermined information, and implementing settlement.

To use a service in the e-commerce mall, the user 14 registers information regarding the user 14 (hereinafter also referred to as user attributes). In one embodiment, the user 14 sets up an account associated with the user attributes of the user 14 in which a user ID (user identification information) that identifies the user 14 is set. The user 14 then logs in with their account to the e-commerce mall provided by the electronic commerce server 11, and uses a service in the e-commerce mall. By setting the user ID, the user 14 can also use the service in the e-commerce mall from a user device connected to the network 13 and different from the user device 12. Types and numbers of user attributes to be registered by the user 14 may be determined in advance by the electronic commerce server 11.

The user attributes will be described by using an example of the user attributes of the user 14. The user attributes of the user 14 may include the address and name of the user 14, and demographic information about the user 14 (demographic information such as gender, age, area of residence, occupation, and family composition of the user 14). Also, the user attributes of the user 14 may include a registration number and a registration name for using web services including the e-commerce mall provided by the electronic commerce server 11. Also, the user attributes of the user 14 may include information related to use history, search history, product purchase history, and information regarding points that can be earned by using a service, regarding web services provided by the electronic commerce server 11, including the e-commerce mall provided by the electronic commerce server 11. Thus, the user attributes of the user 14 may include any type of attribute information, including information associated with the user 14 themself and information regarding user history for web services including the e-commerce mall. Such attributes associated with the registration performed by the user 14 and actual use history for web services can also be referred to as factual user attributes of the user 14.

The user attributes of the user 14 may also include estimated user attributes of the user 14, in addition to the factual user attributes of the user 14. The estimated user attributes of the user 14 may be obtained based on the factual user attributes of the user 14 by, for example, a trained user attribute estimation model. The estimated user attributes may include products in which the user 14 is estimated to be interested, their taste in such products, and/or estimated lifestyle of the user 14.

The user device 12 is, for example, an information processing device such as a smartphone, a mobile phone, a personal digital assistant (PDA), or a tablet terminal. The user device 12 can communicate with the electronic commerce server 11 and the information processing apparatus 10 via the network 13. The user device 12 has a display unit (display surface) such as a liquid crystal display, and the user 14 can perform various operations using a graphical user interface (GUI) equipped on the display unit. The operations include various operations of contents such as images displayed on the screen, including tapping, sliding, and scrolling using a finger, a stylus, or the like. The user device 12 may be provided with a separate display unit, and may be a notebook PC (personal computer) or a desktop PC.

The electronic commerce server 11 can acquire the user attributes of the user 14 who accesses the provided e-commerce mall, in association with the user ID of the user 14. Also, the electronic commerce server 11 can acquire information regarding conversions performed by the user 14 (e.g., conversion history with time information, or history indicating whether or not conversions have been performed within a predetermined period) in association with the user ID. The electronic commerce server 11 provides the information processing apparatus 10 with user attributes and conversion information that are associated with the user ID.

The information processing apparatus 10 calculates an uplift score based on the user attributes and the conversion information associated with the user ID that are acquired from the electronic commerce server 11. The uplift score corresponds to an indicator for selecting a target in order to enhance the treatment effect. A procedure for calculating the uplift score according to the present embodiment will be described later. Although the information processing apparatus 10 and the electronic commerce server 11 are separate devices in FIG. 1, these two devices may alternatively be configured as one device. For example, the information processing apparatus 10 may include the functionality of the electronic commerce server 11.

### Method for Calculating Uplift Score

A method for calculating the uplift score will now be described. In the present disclosure, the uplift score is calculated for each user group, which is a group of one or more users having one or more common (identical) user attributes. In the present disclosure, one or more user groups each having one or more common user attributes are referred to as a user group with a user feature=X. When different user attributes are expressed as x₁, x₂, . . . , user feature=X may be expressed in the form of a vector of one or more user attributes (x₁, x₂, . . . ). For convenience of description, a variable t represents whether a treatment is performed, where t=1 means that a treatment is performed, while t=0 means that no treatment is performed. Further, a user group for which a treatment has been performed (t=1) is referred to as a treated user group, and a user group for which no treatment has been performed (t=0) is referred to as a control user group. A variable y represents whether or not a conversion has been performed (i.e., whether or not a conversion has been reached), where y=1 means that a conversion has been performed, and y=0 means that no conversion has been performed.

### (A) Conventional Methods for Calculating Uplift Score

First, conventional methods for calculating an uplift score will be described. The probability that a conversion is performed (y=1) by the treated user group (t=1) among user groups with user feature=X is expressed as p(y=1|t=1, X). The probability that a conversion is performed (y=1) by the control user group (t=0) among the user groups with user feature=X is expressed as p(y=1|t=0, X). The conventional uplift score can be calculated from a difference between these two probabilities by Equation (1).

$$\begin{matrix}[ Math 1 ] & \\ Uplift score = p ( y = 1 \vert t = 1 , X ) - p ( y = 1 \vert t = 0 , X ) & ( 1 )\end{matrix}$$

The probability p(y=1|t=1, X) and the probability p(y=1|t=0, X) can be estimated by machine learning. For this purpose, for example, the information processing apparatus 10 may use, for training, a certain amount of data out of the data of the user attributes and the conversion information that are associated with the user ID and acquired from the electronic commerce server 11, and may use the remaining data for estimation (prediction).

To calculate the uplift score by estimating the probabilities p(y=1|t=1, X) and p(y=1|t=0, X), for example, an approach such as S (Single)-Learner, which is a single machine learning (ML) model, T (two)-Leaner, which is constituted by two separate ML models, or class transformation can be used. In the following, (A-1) S-learner, (A-2) T-learner, and (A-3) class transformation will be described.

### (A-1) S-Learner

S-Learner is an approach that uses one model in whether or not a treatment is performed used as a feature. By using the variable t representing whether or not a treatment is performed, the probabilities that a conversion is performed (y=1) in cases where a treatment is performed (t=1) and where no treatment is performed (t=0) are estimated, as expressed by Equation (2).

$$\begin{matrix}[ Math 2 ] & \\ \hat{μ} = p ( y = 1 \vert t , X ) & ( 2 )\end{matrix}$$

By using Equation (2), the uplift score based on S-Learner can be calculated as expressed by Equation (3).

$$\begin{matrix}[ Math 3 ] & \\ \begin{matrix}Uplift score = \hat{μ} ( t = 1 ) - \hat{μ} ( t = 0 ) \\ = p ( y = 1 \vert t = 1 , X ) - p ( y = 1 \vert t = 0 , X )\end{matrix} & ( 3 )\end{matrix}$$

### (A-2) T-Learner

T-Learner is an approach using two separate models for the case where a treatment is performed (t=1) and the case where no treatment is performed (t=0). Using the separate models for the cases where a treatment is performed (t=1) and where no treatment is performed (t=0), the probability that a conversion is performed is estimated as expressed by Equation (4).

$$\begin{matrix}[ Math 4 ] & \\ {\hat{μ}}_{0} = p ( y = 1 \vert t = 0 , X ) & ( 4 )\end{matrix}$$

$${\hat{μ}}_{1} = p ( y = 1 \vert t = 1 , X )$$

Using Equation (4), the uplift score based on T-Learner can be calculated as expressed by Equation (5).

$$\begin{matrix}[ Math 5 ] & \\ \begin{matrix}Uplift score = {\hat{μ}}_{0} - {\hat{μ}}_{1} \\ = p ( y = 1 \vert t = 0 , X ) - p ( y = 1 \vert t = 1 , X )\end{matrix} & ( 5 )\end{matrix}$$

### (A-3) Class Transformation

Class transformation defines a target variable Z, which represents an expected result, as expressed by Equation (6) below.

$$\begin{matrix}[ Math 6 ] & \\ Z = \{ \begin{matrix}1 & if t = 1 and y = 1 \\ 1 & if t = 0 and y = 0 \\ 0 & otherwise\end{matrix} & ( 6 )\end{matrix}$$

Using Equation (6), the uplift score based on class transformation can be calculated as expressed by Equation (7).

$$\begin{matrix}[ Math 7 ] & \\ Uplift score = p ( y = 1 \vert t = 1 , X ) - p ( y = 1 \vert t = 0 , X ) & ( 7 )\end{matrix}$$

$$2 p ( Z = 1 \vert X ) - 1$$

The conventional uplift scores are now described using example numerical values. Here, it is assumed that the conversion is a “purchase”, a first user group has user feature=X1, and a second user group has user feature=X2. The purchase probabilities for each of the first and second user groups when a treatment is performed and when no treatment is performed are as follows.

### First User Group:

Purchase probability when a treatment is performed=0.7
Purchase probability when no treatment is performed=0.6

### Second User Group:

Purchase probability when a treatment is performed=0.3
Purchase probability when no treatment is performed=0.2

According to the conventional methods for calculating an uplift score, the uplift score is 0.7−0.6=0.1 in the case of the first user group, and 0.3−0.2=0.1 in the case of the second user group. For both user groups, uplift score=0.1. That is, the uplift scores for the first and second user groups take the same value.

Meanwhile, the overall average purchase probabilities for the first and second user groups are ((0.7+0.6)/2)=0.65 for the first user group and ((0.3+0.2)/2)=0.25 for the second user group. Thus, the probability for the first user group is higher. This means that the purchase possibility for the first user group is higher regardless of whether a treatment is performed. It is understood from these numerical results that a difference may occur in the average purchase probability even if the uplift scores that can be calculated from the difference between the purchase probabilities when a treatment is performed and when no treatment is performed take the same value. The higher the average purchase probability is, the higher the possibility of a purchase by the entire user group originally is, regardless of whether a treatment is performed. Therefore, in the above example, it is considered to be preferable to select the first user group as a target.

As described above, the conventional methods for calculating an uplift score use the difference between the purchase probabilities when a treatment is performed and when no treatment is performed, while the calculated uplift score does not reflect the purchase probability for the entire user group including when a treatment is performed and when no treatment is performed. For this reason, it is possible that the user group to be targeted cannot be selected properly.

### (B) Method for Calculating Uplift Score According to the Present Embodiment

The following describes an uplift score calculation method according to the present embodiment, which is constituted to solve the foregoing problem. The present embodiment proposes a method for calculating an uplift score using an overall probability that a conversion has been reached within the user group. For convenience of description, hereinafter, t represents a treated user group, which is a user group for which a treatment has been performed (t=1), and c represents a control user group, which is a user group for which no treatment has been performed (t=0).

First, p(y=1|t, X) is a probability that, regarding user groups with user feature=X, the treated user group t performs a conversion (y=1), and is expressed as Equation (8), based on the Bayes' theorem.

$$\begin{matrix}[ Math 8 ] & \\ p ( y = 1 \vert t , X ) = \frac{p ( t \vert y = 1 , X ) p ( y = 1 \vert X )}{p ( t \vert X )} & ( 8 )\end{matrix}$$

Here, the probability p(t|y=1, X) is a probability that, regarding the user groups with user feature=X, users that perform a conversion (y=1) are included in the treated user group t. The probability p(y=1|X) is a probability that the user group with user feature=X perform a conversion (y=1). The probability p(t|X) is a probability that a user group included in the user groups with user feature=X is the treated user group t.

Next, p(y=1|c, X) is the probability that, regarding the user groups with user feature=X, the control user group c performs a conversion (y=1), and is expressed as Equation (9), based on the Bayes' theorem.

$$\begin{matrix}[ Math 9 ] & \\ p ( y = 1 \vert c , X ) = \frac{p ( c \vert y = 1 , X ) p ( y = 1 \vert X )}{p ( c \vert X )} & ( 9 )\end{matrix}$$

Here, the probability p(c|y=1, X) is a probability that, regarding the user groups with user feature=X, users that perform a conversion (y=1) are included in the control user group c. The probability p(y=1|x) is a probability that the user groups with user feature=X performs a conversion (y=1). The probability p(c|X) is a probability that a user group included in the user groups with user feature=X is the control user group c.

Subsequently, an uplift score is calculated from Equation (10), using the probabilities p(t|y=1, X), p(c|y=1, X), p(y=1|X), p(t|X), and p(c|X).

$$\begin{matrix}[ Math 10 ] & \\ Uplift score = [ \frac{p ( t \vert y = 1 , X )}{p ( t \vert X )} - \frac{p ( c \vert y = 1 , X )}{p ( c \vert X )} \cdot p ( y = 1 \vert X ) & ( 10 )\end{matrix}$$

The probabilities p(y=1|t(=t=1), X) and p(y=1|c(=t=0), X) can be estimated by the S-Learner and T-Learner approaches, as mentioned above. Further, the probability p(y=1|X) can be estimated based on the purchase history for the user groups with user feature=X. In the present disclosure, the sum of the probabilities p(t|X) and p(c|X) is 1, and each of these probabilities is a preset constant. That is, the user groups with user feature=X are divided in advance into a user group for which a treatment has been performed and a user group for which no treatment is performed. For example, if the probabilities p(t|X) and p(c|X) are respectively 0.5, it means that, regarding a plurality of users in a target population, half (or almost half) of the users is subjected to a treatment, and the other half is not subjected to a treatment. Accordingly, the probabilities p(t|y=1, X) and p(c|y=1, X) can be estimated from Equations (8) and (9).

As can be understood from Equation (10), the uplift score according to the present disclosure is calculated using the purchase probability p(y=1|X) for all user groups with user feature=X, i.e., all user groups with user feature=X regardless of whether they are subjected to a treatment. Next, two methods for calculating an uplift score represented by Equation (10) will be explained.

### (B-1) Retrospective Method

The following describes a method for calculating an uplift score represented by Equation (10), using the retrospective method described in NPL1. This method uses two ML models, which are a first ML model and a second ML model.

The first ML model is an ML model trained to estimate the probabilities p(t|y=1, X) and p(c|y=1, X) in accordance with the retrospective uplift model described in NPL 1. Each of the probabilities p(t|y=1, X) and p(c|y=1, X) is a probability as to whether a user that performs a conversion in the user groups with user feature=X is a user in the treated user group t or the control user group c. The information processing apparatus 10 can train the first ML model using only the data on the case where a conversion is performed (y=1). This can reduce the amount of data used in the estimation. The probabilities p(t|y=1, X) and p(c|y=1, X) are estimated using the trained first ML model.

The second ML model is an ML model trained to estimate the probability p(y=1|X). The probability p(y=1|X) is estimated using the trained second ML model.

The information processing apparatus 10 calculates an uplift score from Equation (10), using the probabilities p(t|y=1, X), p(c|y=1, X), and p(y=1|X) that are estimated as described above, as well as the probabilities p(t|X) and p(c|X) that are constants.

### (B-2) Direct Classification Method

In the direct classification method, one ML model is trained using the following three class-labels. The three class-labels are defined as follows.

$$\begin{matrix}[ Math 11 ] & \\ \begin{matrix}classlabel = 0 & if t = 1 , y = 1 \\ classlabel = 1 & if t = 0 , y = 1 \\ classlabel = 2 & if y = 0\end{matrix} & ( 11 )\end{matrix}$$

Using these three class-labels, the information processing apparatus 10 trains the ML model to estimate the following three probabilities.

$$\begin{matrix}[ Math 12 ] & \\ \begin{matrix}p ( 0 ) = p ( t \vert y = 1 , X ) \\ p ( 1 ) = p ( c \vert y = 1 , X ) \\ p ( 2 ) = 1 - p ( y = 1 \vert X ) ∴ p ( y = 1 \vert X ) = 1 - p ( 2 )\end{matrix} & ( 12 )\end{matrix}$$

The probabilities p(t|y=1, X), p(c|y=1, X), and p(y=1|X) are estimated using the trained ML model. The information processing apparatus 10 calculates an uplift score from Equation (10), using the probabilities p(t|y=1, X), p(c|y=1, X), and p(y=1|X) that are estimated as described above, as well as the probabilities p(t|X) and p(c|X) that are constants.

The uplift score calculated by the direct classification method will be described using example numerical values. It is assumed that the conversion is a “purchase”, a first user group has user feature=x₁, and a second user group has user feature=x₂. Also, it is assumed that the probabilities p(0), p(1), and p(2) are estimated for each of the first and second user groups as follows.

### First User Group:

$$P ( 0 ) = 0.5 , p ( 1 ) = 04 , p ( 2 ) = 0.1$$

### Second User Group:

$$P ( 0 ) = 02 , p ( 1 ) = 0.1 , p ( 2 ) = 0.7$$

When the probabilities p(t|X) and p(c|X) are respectively 0.5, the uplift score calculated by Equation (10) is 0.045 for the first user group, and 0.015 for the second user group. According to the uplift score calculation method according to the present embodiment, it is possible to calculate the uplift score reflecting the purchase probabilities for each of the first and second user groups.

Although two methods have been described above, the information processing apparatus 10 may estimate the probabilities p(t|y=1, X), p(c|y=1, X), and p(y=1|X) using other methods. The information processing apparatus 10 may then calculate an uplift score from Equation (10), using the estimated probabilities p(t|y=1, X), p(c|y=1, X), and p(y=1|X), as well as the probabilities p(t|X) and p(c|X) that are constants.

### Conceptual Diagram of Uplift Score Calculation Processing

FIG. 2 is a conceptual diagram of uplift score calculation processing according to the present embodiment. As mentioned above, the uplift score is calculated as expressed by Equation (10). Here, as shown in FIG. 2, estimated values are used as the probabilities p(t|y=1, X), p(c|y=1, X), and p(y=1|X), and predetermined constants are used as the probabilities p(t|X) and p(c|X). The uplift score is calculated by Equation (10) using these values.

### Configuration of Electronic Commerce Server

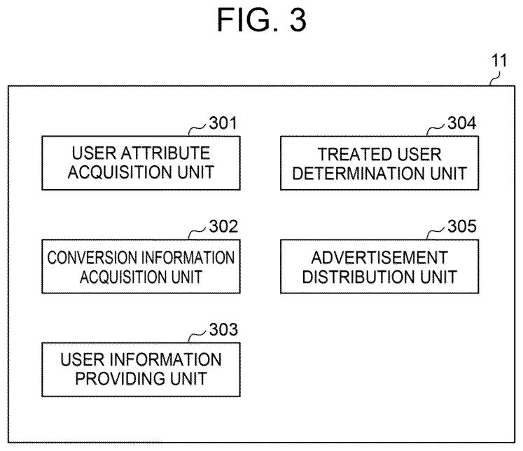

FIG. 3 shows one example of a functional configuration of the electronic commerce server 11 according to the present embodiment. Here, only the functional configuration associated with the processing related to the present embodiment is shown, and other functional configurations including functional configurations for providing services related to electronic commerce are omitted. As one example of its functional configuration, the electronic commerce server 11 includes a user attribute acquisition unit 301, a conversion information acquisition unit 302, a user information providing unit 303, a treated user determination unit 304, and an advertisement distribution unit 305. For convenience of description, the user device 12 and the user 14 are referred to, but the same description can also be applied to other user devices capable of communicating with the electronic commerce server 11, and users of these user devices.

The user attribute acquisition unit 301 acquires, from the user device 12, one or more user attributes of the user 14 that are associated with the user ID of the user 14. The conversion information acquisition unit 302 acquires, from the user device 12, conversion information (e.g., conversion history with time information, whether conversion has been performed within predetermined period) regarding the user 14 in the e-commerce mall provided by the electronic commerce server 11, the conversion information being associated with the user ID of the user 14. The user information providing unit 303 provides the information processing apparatus 10 with the one or more user attributes and conversion information regarding the user 14 that are associated with the user ID of the user 14. The user information providing unit 303 may provide the information processing apparatus 10 with the user attributes and the conversion information regarding the user 14 each time user attributes and conversion information are acquired, or may provide the information processing apparatus 10 with the user attributes and the conversion information regarding the user 14 that have been accumulated within a certain period. The treated user determination unit 304 acquires an uplift score for each user group calculated by the information processing apparatus 10, and determines which users are to be treated users, i.e., determines a treated user group (also referred to as target users). Specifically, the treated user determination unit 304 determines a treated user ID group as the treated user group. The advertisement distribution unit 305 functions as a treatment unit that executes a treatment, and distributes an advertisement for encouraging the treated user group to perform a conversion, such as a purchase. Specifically, the advertisement distribution unit 305 distributes an advertisement to user IDs identified by the treated user ID group. Note that the advertisement may be generated by the advertisement distribution unit 305, or may be generated by a predetermined function within the electronic commerce server 11, or may be generated and acquired by another device. Note that, in the present embodiment, the advertisement distribution unit 305 executes a treatment by distributing an advertisement, but it may alternatively be configured to execute a treatment in another form.

### Configuration of Information Processing Apparatus

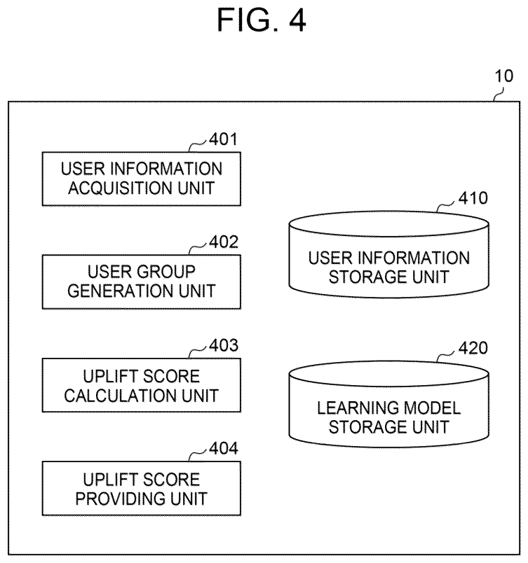

FIG. 4 shows an example of a functional configuration of the information processing apparatus 10 according to the present embodiment. As one example of its functional configuration, the information processing apparatus 10 includes a user information acquisition unit 401, a user group generation unit 402, an uplift score calculation unit 403, an uplift score providing unit 404, a user information storage unit 410, and a learning model storage unit 420. The learning model storage unit 420 can store one or more machine learning models (e.g., data representing architecture and various parameters) used to calculate uplift scores. Although the user device 12 and the user 14 are referred to for convenience of description, the same description can also be applied to other user devices and users.

The user information acquisition unit 401 acquires, from the electronic commerce server 11, user information including one or more user attributes and conversion information regarding the user 14 that are associated with the user ID of the user 14. The user information acquisition unit 401 stores the acquired user information in the user information storage unit 410. The user group generation unit 402 generates one or more user groups by grouping one or more users having one or more common (identical) user attributes, based on the user attributes stored in the user information storage unit 410. The uplift score calculation unit 403 calculates an uplift score for each of the user groups generated by the user group generation unit 402. The uplift score calculation method is as described above.

The uplift score calculation unit 403 can calculate the uplift score using one or more machine learning models stored in the learning model storage unit 420. The uplift score providing unit 404 provides the electronic commerce server 11 with the calculated uplift score for each user group.

### Hardware Configuration of Information Processing Apparatus

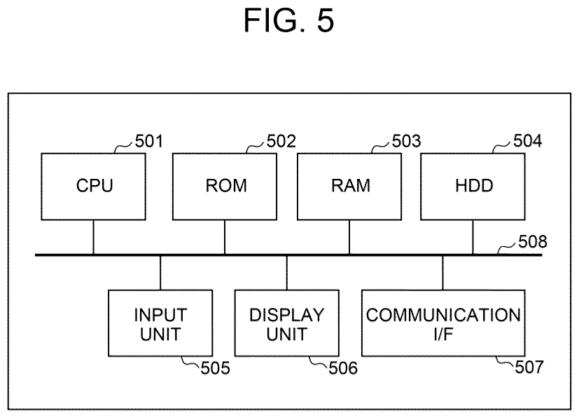

Next, an example hardware configuration of the information processing apparatus 10 is described. FIG. 5 is a block diagram showing an example of a hardware configuration of the information processing apparatus 10 according to the present embodiment. Note that the electronic commerce server 11 has the same hardware configuration.

The information processing apparatus 10 according to the present embodiment can be implemented on one or more computers or mobile devices of any type, or any other processing platforms.

Referring to FIG. 5, an example is shown in which the information processing apparatus 10 is implemented on a single computer, but the information processing apparatus 10 according to the present embodiment may be implemented on a computer system that includes a plurality of computers. The plurality of computers may be connected to each other communicably by a wired or wireless network.

As shown in FIG. 5, the information processing apparatus 10 may include a central processing unit (CPU) 501, a read only memory (ROM) 502, a random access memory (RAM) 503, a hard disk drive (HDD) 504, an input unit 505, a display unit 506, a communication interface (I/F) (communication unit) 507, and a system bus 508. The information processing apparatus 10 may also be provided with an external memory.

The CPU 501 serves to perform overall control of the operations of the information processing apparatus 10, and controls each of the constituent units 502 to 507 via the system bus 508, which is a data transmission path.

The ROM 502 is a non-volatile memory that stores control programs and the like necessary for the CPU 501 to execute processing. The programs include instructions (code) for performing the above-described processing according to the embodiment. Note that the programs may also be stored in a non-volatile memory such as the HDD 504 or a solid state drive (SSD), or in an external memory such as a removable storage medium (not shown).

The RAM 503 is a volatile memory and functions as a main memory, a work area, and the like of the CPU 501. That is, the CPU 501 realizes various functional operations by loading necessary programs and the like into the RAM 503 from the ROM 502 to execute processing, and executing the loaded programs and the like. The RAM 503 may include the user information storage unit 410 and the learning model storage unit 420 shown in FIG. 4.

The HDD 504 stores various types of data, information, and the like necessary for the CPU 501 to perform processing using programs, for example. Also, the HDD 504 stores, for example, various types of data, information, and the like obtained by the CPU 501 performing processing using programs or the like.

The input unit 505 is constituted by a keyboard and a pointing device such as a mouse.

The display unit 506 is constituted by a monitor such as a liquid crystal display (LCD). The display unit 506 may also function as a graphical user interface (GUI) by being combined with the input unit 505.

The communication I/F 507 is an interface for controlling communication between the information processing apparatus 10 and an external device. The communication I/F 507 provides an interface with the network, and executes communication with the external device via the network. Various data, parameters, and the like are transmitted to and received from the external device via the communication I/F 507. The communication I/F 507 in the present embodiment may execute communication via a wired local area network (LAN) or a dedicated line conforming to a communication standard such as Ethernet (registered trademark). However, the network that can be used in the present embodiment is not limited thereto, and may be constituted by a wireless network. Examples of wireless networks include wireless personal area networks (PANs) such as Bluetooth (registered trademark), ZigBee (registered trademark), and ultra wide bands (UWBs). Examples of wireless networks also include wireless local area networks (LANs) such as Wireless Fidelity (Wi-Fi) (registered trademark) and wireless metropolitan area network (MANs) such as WiMAX (registered trademark). Examples of wireless networks also include a wireless wide area network (WANs) such as 4G or 5G. Note that the network need only be capable of communicably connecting the devices to each other and enabling communication, and the standard, scale, and configuration of communication are not limited to those described above.

At least some of the functions of the elements of the information processing apparatus 10 shown in FIG. 4 can be realized by the CPU 501 executing programs. However, at least some of the functions of the elements of the information processing apparatus 10 shown in FIG. 4 may be operated as dedicated hardware. In this case, the dedicated hardware operates under the control of the CPU 501.

### Processing Flow of Information Processing System

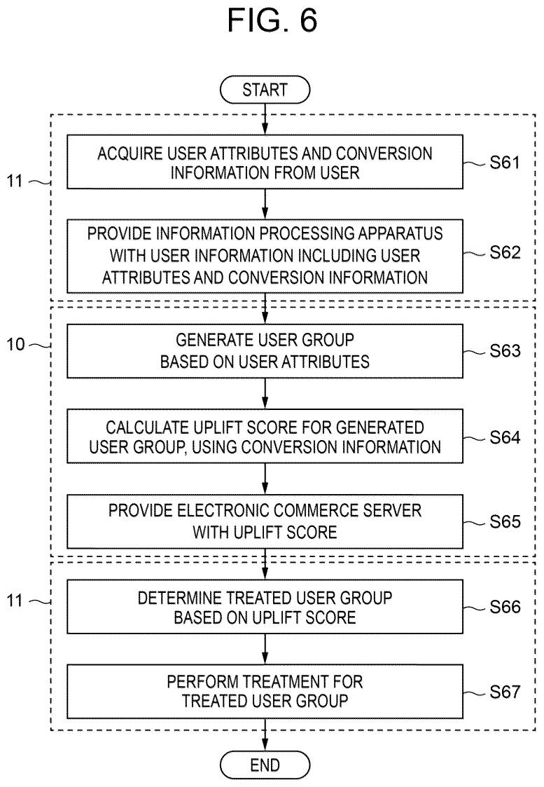

FIG. 6 is a flowchart of processing executed by the information processing system according to the present embodiment. It is assumed that processing in S61, S62, S66, and S67 is executed by the electronic commerce server 11, and the processing from S63 to S65 is executed by the information processing apparatus 10. However, if the information processing apparatus 10 and the electronic commerce server 11 are configured as one device, the entire processing may be executed by this device.

In S61, the user attribute acquisition unit 301 of the electronic commerce server 11 acquires one or more user attributes of a plurality of users at any time, and the conversion information acquisition unit 302 acquires conversion information regarding the plurality of users at any time. In S62, the user information providing unit 303 of the electronic commerce server 11 provides the information processing apparatus 10 with the user attributes and the conversion information as user information. The user information is acquired by the user information acquisition unit 401 of the information processing apparatus 10, and is stored in the user information storage unit 410.

In S63, the user group generation unit 402 of the information processing apparatus 10 generates one or more user groups by grouping one or more users having one or more common (identical) user attributes, based on the user attributes stored in the user information storage unit 410. For convenience of description, it is assumed that the user group generation unit 402 generates a user group with user feature=X. For description of FIG. 6, this user group is also referred to as a user group X. The user group generation unit 402 divides the user group X into a first user group t (i.e., treated user group) for which a treatment for encouraging a predetermined conversion has been performed, and a second user group c (i.e., control user group) for which the treatment has not been performed. In the present embodiment, users are grouped such that half (or nearly half) of them are in the first user group t and the other half are in the second user group c. As a result, the probabilities p(t|X) and p(c|X) are respectively 0.5.

In S64, the uplift score calculation unit 403 calculates an uplift score for the user group X generated by the user group generation unit 402. In the present embodiment, as described above, the uplift score calculation unit 403 estimates the probability p(t|y=1, X) that a user who has reached a conversion is included in the first user group t, and the probability p(c|y=1, X) that a user who has reached a converted is included in the second user group c, using a means such as a machine learning model. Also, as described above, the uplift score calculation unit 403 estimates the overall probability p(y=1|X) that a conversion has been reached within the user group X, using a means such as a machine learning model. For convenience of description, the probabilities p(t|y=1, X), p(c|y=1, X), and p(y=1|X) are referred to as a first probability, a second probability, and a third probability, respectively. Subsequently, the uplift score calculation unit 403 calculates the uplift score based on the first probability, second probability, and third probability. More specifically, the uplift score calculation unit 403 calculates an uplift score for the user group X according to Equation (10), using the first probability, second probability, third probability, and the probabilities p(t|X) and p(c|X). The information processing apparatus 10 calculates the uplift score for one or more user groups through processing from S63 to S65, and provides the electronic commerce server 11 with the calculated uplift score for each user group. The provided uplift score for the one or more user groups is acquired by the treated user determination unit 304 of the electronic commerce server 11.

In S66, the treated user determination unit 304 of the electronic commerce server 11 determines a treated user group based on the uplift score for the one or more user groups. For example, the treated user determination unit determines a user group having an uplift score higher than a predetermined value as the treated user group. The predetermined value is, for example, 0.5. Subsequently, in S67, the advertisement distribution unit 305 of the electronic commerce server 11 performs a treatment for the treated user group. For example, the advertisement distribution unit 305 distributes an advertisement that encourages the treated user group to perform a conversion, such as a purchase. The advertisement distribution unit 305 may also perform a treatment using user features of the treated user group. For example, the advertisement distribution unit 305 may use user features of the treated user group to distribute an advertisement that encourages the treated user group to perform a conversion on a product associated with the user features. Further, the advertisement distribution unit 305 may distribute an advertisement that encourages the treated user group to perform a conversion on a product associated with user features similar to the user features of the treated user group. The similar user features may be acquired by machine learning.

As described above, the uplift score is calculated while considering the overall probability that a purchase has been made among all the users, and therefore, the calculated uplift score can be an indicator that represents a purchase trend. Further, since the calculated uplift score represents a purchase tendency, the return on investment (ROI) is expected to improve as a result of the treatment using the uplift score.

Note that although a specific embodiment has been described above, the embodiment is a mere example and is not intended to limit the scope of the invention. The apparatus and method described in this specification may be implemented in forms aside from the embodiment described above. It is also possible to appropriately make omissions, substitutions, and modifications to the embodiment described above without departing from the scope of the invention. Implementations with such omissions, substitutions, and modifications are included in the scope of the patent claims and their equivalents, and belong to the technical scope of the present invention.

The disclosure includes the following embodiments.
[1] An information processing apparatus comprising: a grouping unit configured to divide a user group consisting of a plurality of users into a first user group for which a treatment for encouraging a predetermined conversion has been performed, and a second user group for which the treatment has not been performed; a first estimation unit configured to estimate a first probability that a user who has reached the conversion is included in the first user group, and a second probability that a user who has reached the conversion is included in the second user group; a second estimation unit configured to estimate a third probability that is an overall probability that the conversion has been reached within the user group; and a calculation unit configured to calculate an uplift score representing an effect of the treatment with respect to the user group, using the first probability, the second probability, and the third probability.
[2] The information processing apparatus according to [1], wherein the user group has one or more common user attributes.
[3] The information processing apparatus according to [1] or [2], further comprising: a treatment unit configured to perform the treatment for the user group if the uplift score is higher than a predetermined value.
[4] The information processing apparatus according to [3], wherein the user group has one or more common user attributes, and the treatment unit performs the treatment using the one or more common user attributes of the user group.
[5] The information processing apparatus according to any one of [1] to [4], wherein the conversion is a purchase of an item provided by a service for electronic commerce.
[6] The information processing apparatus according to any one of [1] to [5], wherein performing the treatment is distributing an advertisement related to a service.
[7] The information processing apparatus according to any one of [1] to [6], wherein the first estimation unit estimates the first probability and the second probability using a first machine learning model, and the second estimation unit estimates the third probability using a second machine learning model.
[8] The information processing apparatus according to any one of [1] to [6], wherein the first estimation unit estimates the first probability and the second probability using a first machine learning model, and the second estimation unit estimates the third probability using the first machine learning model.

What is claimed is:

1. An information processing apparatus comprising:
a grouping unit configured to divide a user group consisting of a plurality of users into a first user group for which a treatment for encouraging a predetermined conversion has been performed, and a second user group for which the treatment has not been performed;
a first estimation unit configured to estimate a first probability that a user who has reached the conversion is included in the first user group, and a second probability that a user who has reached the conversion is included in the second user group;
a second estimation unit configured to estimate a third probability that is an overall probability that the conversion has been reached within the user group; and
a calculation unit configured to calculate an uplift score representing an effect of the treatment with respect to the user group, using the first probability, the second probability, and the third probability.

2. The information processing apparatus according to claim 1,
wherein the user group has one or more common user attributes.

3. The information processing apparatus according to claim 1, further comprising:
a treatment unit configured to perform the treatment for the user group if the uplift score is higher than a predetermined value.

4. The information processing apparatus according to claim 3,
wherein the user group has one or more common user attributes, and the treatment unit performs the treatment using the one or more common user attributes of the user group.

5. The information processing apparatus according to claim 1,
wherein the conversion is a purchase of an item provided by a service for electronic commerce.

6. The information processing apparatus according to claim 1,
wherein performing the treatment is distributing an advertisement relate to a service.

7. The information processing apparatus according to claim 1,
wherein the first estimation unit estimates the first probability and the second probability using a first machine learning model, and
the second estimation unit estimates the third probability using a second machine learning model.

8. The information processing apparatus according to claim 1,
wherein the first estimation unit estimates the first probability and the second probability using a first machine learning model, and
the second estimation unit estimates the third probability using the first machine learning model.

9. An information processing method comprising:
dividing a user group consisting of a plurality of users into a first user group for which a treatment for encouraging a predetermined conversion has been performed, and a second user group for which the treatment has not been performed;
estimating a first probability that a user who has reached the conversion is included in the first user group, and a second probability that a user who has reached the conversion is included in the second user group;
estimating a third probability that is an overall probability that the conversion has been reached within the user group; and
calculating an uplift score representing an effect of the treatment with respect to the user group, using the first probability, the second probability, and the third probability.

10. A non-transitory computer readable medium storing an information processing program for causing a computer to execute:
grouping processing for dividing a user group consisting of a plurality of users into a first user group for which a treatment for encouraging a predetermined conversion has been performed, and a second user group for which the treatment has not been performed;
first estimation processing for estimating a first probability that a user who has reached the conversion is included in the first user group, and a second probability that a user who has reached the conversion is included in the second user group;
second estimation processing for estimating a third probability that is an overall probability that the conversion has been reached within the user group; and
calculation processing for calculating an uplift score representing an effect of the treatment with respect to the user group, using the first probability, the second probability, and the third probability.
